(19) United States
(12) Patent Application Publication
(10) Pub. No.: US 2008/0072798 A1
(43) Pub. Date: Mar. 27, 2008

(54) Improved Asphaltic Concrete Compositions That Contain Anhydrite As Anti-Stripping Asphalt Agents

(75) Inventors: Armando Garcia Luna, Monterrey (MX); Jamie Valenzuela Grado, Chihuahua (MX)

Correspondence Address: ROTHWELL, FIGG, ERNST & MANBECK, P.C., 1425 K STREET, N.W., SUITE 800, WASHINGTON, DC, 20005, US

(73) Assignee: GCC TECHNOLOGY AND PROCESSES S.A., Lausanne (CH)

(21) Appl. No.: 11/815,069

(22) PCT Filed: Jul. 1, 2005
(86) PCT No.: PCT/IB05/02558

§ 371 Date: Oct. 10, 2007

(30) Foreign Application Priority Data
Jan. 31, 2005 (MX) PA/A/2005/001210

(51) Int. Cl. C04B 7/02

(52) U.S. Cl. 106/735

(57) ABSTRACT

The present invention describes improved asphaltic concrete compositions resistant to the stripping, as well as their methods of obtaining. Also compositions that contain anhydrite are described that result to be useful like anti-stripping agents of asphaltic concretes. The described anti-stripping compositions allow to improve the properties of union of the asphaltic concrete compositions after their application, increasing with it the useful lifetime of coverings elaborated with these materials.

### CROSS REFERENCE TO RELATED APPLICATION(S)

This application is a 35 U.S.C. § 371 National Phase Entry Application from PCT/IB2005/002558, filed Jul. 1, 2005, and designating the United States.

### BACKGROUND OF THE INVENTION

1. Field of the Invention

This invention is related to the development of asphaltic concrete compositions resistant to stripping, specifically with compositions that contain anhydrite to improve the properties of asphalt adhesion.

2. Description of the Related Art

The communication of the human populations through terrestrial routes is of vital importance. In fact the great majority of products or services that a population requires, needs efficient terrestrial mass media to obtain that such benefits arrive at the precise moment. For it, it is very important to count with a suitable infrastructure of ground communication lines through roads or highways. In this sense, from the sprouting of the automobile, it was necessary to implement improvements to the terrestrial routes with the purpose of facilitating the circulation of vehicles on a safe way; for this they have been used materials as concrete or asphalt, being the asphalt the material that has the more technological conveniences.

At the present time the surfaces of roads, highways and parking spaces are paved with asphaltic concrete, which offers a resistance to the suitable friction to support the traffic of vehicles. The asphaltic concrete is obtained by means of a mixture of stony aggregates (sand, burdens or fragmented stone) with convenient amounts of asphalt (asphalt cement) to high temperatures. For its application, the composition is placed on the surface to be paved and it is distributed of homogeneous way until generating thin layers of variable thickness. Due to the previous characteristics, the asphaltic carpets can simply be repaired by hot asphaltic concrete addition to any defect that can be developed in the surface. Also, the pavements of asphaltic concrete can be covered easily by the application of additional layers of hot asphaltic concrete on the surfaces of roads that need repair.

In spite of the numerous benefits that represent the use of asphaltic concrete like paving material, it presents certain disadvantages.

The asphalts and stony aggregates constitute the main elements of construction of asphalt pavements. The asphalts, that are a complex mixture of nonpolar hydrocarbons derivates of the refinement of petroleum, exhibit a low affinity towards the water. In the other hand, the surfaces of stony aggregates are typically polar, with which they have a high affinity by the water. These differences in the polarity and the affinities towards the water, causes that these materials present low affinity between them. As a result of this low relation of affinities between the materials, a poor adhesion among them is generated, causing a short life for the asphalt pavement. The poor adhesion between asphalt and the aggregate is accelerated by the water presence, that comes from rain or from subsoil, which preferably wets the aggregate, causing a separation between these materials. This breaking of the sticky union between the aggregates surface and the asphalt cement is known like stripping and is one of the most important problems that they present.

One of the most well known alterations caused by this phenomenon is the generation of deformations, longitudinal and cross-sectional crackings and loss of the asphaltic carpet in located zones generating holes. Due to the loss of integrity of the asphaltic carpets, these become uncertain for the vehicles circulation and can cause accidents.

Consequently, the presence of the stripping phenomenon in the asphaltic concrete causes a shorter life of the pavement and the necessity to implement actions of permanent maintenance and reparation of all paved terrestrial network, generating with it high costs.

For the reasons exposed above, the reduction of the stripping effect on the asphaltic concrete in the pavement has a great interest, with the objective to improve the conditions of the paved roads, and to reduce the costs of its maintenance.

With the purpose of reducing or eliminating the stripping effect that appears in the pavement, multiple options and methods have been developed until the moment.

The stripping phenomenon of the asphaltic concrete can be avoided or be diminished by the control and determination of the properties of the asphalt cement, the stony aggregate and the mixture of manufacture. Also the conditions of the environment, the frequent use of the asphalt carpet and the use of anti-stripping agents, also contribute to the elimination of this undesirable effect.

The use of diverse agents to help and to promote the capacity of adhesion of asphalt is well-known, being the most important the use of chemical agents. Greasy amines and the polymers are the most common, which are added directly to asphalt before being mixed with the stony aggregate.

Diverse useful anti-stripping agents have been described, such as mineral acid salts of amines¹, phosphorus compounds², amine substituted polymers (3-dimethylaminopropyl methacrylate)³ and latex to cover aggregates for asphalts⁴.

In spite of their effectiveness, the chemical agents are only effective in the short term, considering the time of life and use of the pavement.

On the other hand, the methods that use chemical agents have diverse disadvantages, such as the use of compounds that can be toxic for the environment, the necessity to implement specific methods of obtaining that increase the cost and the time of obtaining the asphaltic concrete to being applied, as well as the generation of asphaltic concrete that has inconvenient physical characteristics, such as loss of the compressive strength. For example, in the formulations of asphaltic concrete that contain active amines like anti-stripping agents, there has been found that these agents cause problems during the process of manufacture of asphaltic concrete, since its inclusion generates high viscosities, with which frequently appear fluidity problems of the materials and, therefore, in its handling.

Also the use of certain aggregates treated previously, for example clays, limits the application of such methods and causes in certain types of clay aggregates, the absorption of important amounts of water⁵

On the other hand, the calcium hydroxide (Ca(OH)₂) also has been used like anti-stripping agent⁶, which is added directly to the dampened surface of the aggregate in grout form, before being covered by asphalt. This compound foments the chemical adhesion of asphalt with the silica of the aggregate, obtaining a greater adhesion between the components of asphalt, being used commonly in concentrations from 0.5 to 2% in weight.

There has been observed that the calcium hydroxide used in mixtures of asphaltic concrete causes a smaller disintegration of the asphaltic carpets in comparison with mixtures of asphaltic concrete which contain chemical agents; nevertheless, this can only be obtained with the use of calcium hydroxide or hydrated lime of certain purity and chemical composition, which limits the extensive application of the compound.

In this sense, the process of obtaining calcium hydroxide from the limestone calcination, generates diverse products that are denominated lime and they have different physical and chemical properties, affecting the performance of the compound. This effect is because the obtaining process causes an undesirable transformation in some components that conform the limestone wherein it is possible to find these components in a natural way like polluting agents of the same one (calcium carbonate with different degrees and types of polluting agents like silica oxides, aluminum, iron, magnesium, manganese, etc.).

For the mentioned above, it is necessary to obtain improved asphaltic concrete compositions with greater times of average life. Also it is necessary to obtain improved anti-stripping agents that allow the reduction of the stripping effect in the asphaltic concrete, without being toxic to the environment and which can be used in an extensive way.

### SUMMARY OF THE INVENTION

It is an objective of the present invention to provide an asphaltic concrete composition with a greater lifetime than the compositions known until the moment.

Is another of the objectives of the invention to provide a composition of asphaltic concrete resistant to the stripping phenomenon.

Another one of the objectives of the invention is to provide compositions integrated by cement clinker or Portland cement and anhydrous calcium sulphate (anhydrite) as effective anti-stripping agents to avoid or to diminish the asphalt stripping effect.

It is another objective of the present invention to obtain asphalt anti-stripping agents nontoxic to the atmosphere and to the living beings.

It is also another objective of the present invention to provide low cost anti-stripping agents, with good compressive strength, abrasion resistance and with good behavior under the water or with excellent hydraulic properties.

Another of the objectives of the present invention is to provide an effective method to improve the anti-stripping properties of asphalt compositions.

### DETAILED DESCRIPTION OF THE INVENTION

The present invention provides improved asphaltic concrete compositions resistant to the stripping for paving and related applications to generate asphalt coverings.

For the present invention, an anti-stripping composition which consists of a mixture conformed with clinker of Portland cement and anhydrous calcium sulphate (anhydrite), it is mixed with stony aggregates that commonly are used in the obtaining of asphaltic concrete; the obtained mixture is mixed later with asphalt cement to form the compositions of asphaltic concrete of the invention. The asphaltic concrete is then applied to the surface to be covered by conventional methods of application.

Taking advantage of the physical and chemical characteristics that the cementitious that contain calcium sulphate, like for example the development of high compressive strengths, the present invention provides asphaltic concrete compositions with this characteristic but they do not present the problems associated to the use of anhydrous calcium sulphate in other materials.

Its know in the construction industry that the calcium sulphate and Portland cement combination allow the generation of cementitious that develop high compressive strengths, how ever the physical and chemical interaction that have the components that conform this cementitious materials originates the formation of compounds such as the plaster of Paris (CaSO₄.½H₂0) and the ettringite (3CaO.Al₂O₃.CaSO₄.32H₂O)^{7,8}, which causes undesired effects of cementitious volume increase, causing its breaking, cracking and crumble. Due to just mentioned, the industry has limited in an important way the use of such mixtures.

Although the compositions of the invention use high amounts of anhydrous calcium sulphate, surprising the events of undesirable secondary chemical agent formation that causes the observed adverse effects in other cementitious do not acquire importance. In consequence, the compositions of the invention develop high compressive strengths, which allows consequently to increase the concrete resistance of the asphalt to the passage of heavy vehicles. Also the cementitious interaction with the rest of the elements of the asphaltic concrete, allows increasing in an important way the necessary association among them for the generation of long life asphaltic concrete and without presenting important stripping.

The compositions of asphaltic concrete of the invention comprise:

a) Asphalt cement,

b) Stony aggregates, and

c) An anti-stripping asphalt composition constituted by a mixture of:
Portland cement or Portland cement clinker, and
Anhydrous calcium sulphate.

The anti-stripping asphalt composition used in the present invention, as it describes Garcia Luna⁹, is constituted by a mixture of Portland cement and anhydrous calcium sulphate, or clinker and anhydrous calcium sulphate, this last one provided to the mixture, in both cases, in form of anhydrous gypsum or anhydrite.

The anhydrite is obtained as a waste product in the industrial production of hydrofluoric acid and/or phosphorus pentoxide, or as a result of burning lime at a temperature between 600° C. and 1200° C. or well as natural anhydrite present in deposits. When considering itself the anhydrite basically as a product of industrial remainder, is not used in a direct and extensive way like the main raw material for obtaining of cementitious, situation that is taken advantage by the present invention. The direct anhydrite use in the composition of the invention, allows to obtain advisable anti-stripping compositions at very low cost because it is not necessary to add to this raw material some previous mechanical or energy treatment to be able to occupy it.

With respect to the Portland cement, it can be use the ordinary type-1 (T1), as well the type-3 and type-4, or preferably those in which the amount of tricalcium aluminate has been controlled, being these resistant to sulphate attacks; such is the case of the type-2 (T2) and type-5 (T5) cements that have moderated and high resistance to the sulphates respectively; also there can be use mixtures of the diverse types of the Portland cement mentioned above. For the present invention, in the anti-stripping composition, the anhydrite and the Portland cement are in proportions in weight with respect to the total weight of the agent, between 60 to 75% of anhydrite and 25 to 40% of Portland cement, of which are preferred those in which the anhydrite is in a proportion in weight of 60% and the Portland cement in a proportion in weight of 40%. Also the anti-stripping compositions contain a maximum of 2% of alumina, 60% of CaO and a 38% of sulphates, reason why they do not present high level of acidity in comparison with the anhydrites obtained as subproducts, avoiding in this way elements considered toxic. In comparison with anti-stripping agents commonly used to improve the concrete properties of adhesion in asphalt, the agents used here are not toxic or polluting due to their low concentrations of aluminum and/or acids. This repels positively as well in the ecological characteristics of the asphaltic concrete, and it allows integrating in an efficient way the anti-stripping composition with the rest of the components of the concrete. Also, the used does not interfere negatively with the properties of the rest of the components of the asphaltic concrete, reason why the physical and chemical effect that these elements provide to the compositions of the invention is not affected.

On the other hand, the characteristics of the anti-stripping composition used here for the asphaltic concrete compositions of the invention, allow homogenous mixing of the concrete mixture integrating themselves with the rest of the components in a very efficient way and eliminating the application of additional stages of mixed with a consequent important saving of energy.

The used anti-stripping compositions in the asphaltic concrete compositions of the invention, they are obtained as describes Garcia Luna⁹, using simple grounding and mixing procedures along of Portland cement clinker and a not fine anhydrite material, while the anhydrite fine material is being send directly to the finished product. By means of this method a fineness of mesh 325 in a 80% of particles of the obtained product is obtained like minimum, preferably in a 99%. On the other hand, the values of compressive strength that reach the anti-stripping compositions described here according to norms ASTM, oscillate between ≧180 Kg/cm² to ≧250 Kg/cm² to the 7 and 28 days corresponding.

The anti-stripping composition can be applied to the asphaltic concrete composition of the invention in proportions from 0.5 to 3% in weight with respect to the total weight of the asphaltic concrete composition, although proportions from 1 to 2% in weight are preferred. The asphalt cements that can be used altogether with the invention are typically those that are used for pavements or asphalt carpets of bearing, repair of the same ones or for purposes of maintenance. In this sense any type of asphalt can be used, nevertheless those that are more frequently used are preferred, like for example petroleum asphalts that are obtained like product of the refinement of petroleum and predominantly used in paving.

Also, the stony aggregates that can be used are those that commonly are used in the production of conventional asphalt, being these a mixture that contains rocks, fractured stones, stones, burdens and/or sand. The aggregates can be used with different particle sizes, from average to fine sizes or by a combination of such. For different paving applications different sizes from the aggregate are required, which is provided generally in a determined rank of size.

For the obtaining of the asphaltic concrete compositions of the invention, the anti-stripping compositions of the invention are mixed with stony aggregates previously dampened to obtain a previous adhesion between these materials in the mentioned proportions above. The obtained mixture then is mixed with the asphalt cement in a continuous way in a standard mixer until obtaining a homogenous mixture, with which the mixtures of asphaltic concrete of the invention are obtained, ready to be applied.

In one of the embodiment of the invention, the anti-striping composition described here is added to the asphalt mixture directly to stony aggregates either in dust or in form of slurry. In the first case, the stony aggregates are dampened in 2 to 3% on their condition of saturated dry surface and obtained from a load hopper or storage silo by a band; later on the formed bed of aggregate, the anti-stripping agent is added in dust. For the second case, the anti-stripping agent adds itself in form of slurry on the aggregate that can be introduced in the mixture or it is piled up to improve the contact of the agent and the aggregate during the rest.

The improved asphaltic concrete compositions of the invention that are obtained with the methods previously described, can be used to pave ways, highways, exit inclines, streets, parking spaces or ways using conventional procedures. Also, the pavements obtained with the improved asphaltic concrete of the invention containing the anti-stripping compositions described here, are less susceptible to present the effect of stripping in comparison with the conventional asphaltic concrete, increasing with it their time of duration and use. In this sense, asphalt test tubes in humid conditions retain the initial mechanical resistance with time when they contain the anti-stripping composition described here, whereas asphalt test tubes that do not contain it lose this resistance with greater facility, being observed important loosening of the asphalt that covers the aggregate.

Although the anti-stripping compositions of the present invention contain calcium sulphate and Portland cement, they do not present the formation of mentioned undesirable compounds, with which the properties of the anti-stripping agent result, of surprising way, in better anti-stripping properties. On the other hand, such compositions are not toxic and eliminate the contamination risk that other nonbiodegradable compositions with high acid concentrations or substances represent, as polymeric complexes of high molecular weight.

Also, the fineness which the particles of the anti-stripping compositions described here have, is in high percentage (99%), which allows a greater interaction with the aggregate and the asphalt cement, repelling in the physical properties of the mixture, as well as in a better handling of the product, as much in its transport as in its mixed with other elements, for example for the formation of asphaltic carpet.

The asphaltic concrete of the invention use cementitious compositions with high amounts of anhydrous calcium sulphate in anhydrite form like anti-stripping agents, by their addition to asphalt cement compositions for the obtaining of asphalt carpets, filler material, coverings with asphalt and other related applications.

The anti-striping compositions used in the present invention are distinguished to have similar physical properties to those of the Portland cement, good compressive strength, good resistance to the abrasion and good behavior under the water, whereas at the same time they are agents of low cost who increase the anti-striping properties of asphalt. These properties allow providing the asphalt compositions better resistance to the pass of heavy vehicles, a better behavior to the water and the humidity, as well as an elimination or very significant diminution of the anti-stripping effect, repelling with it in a greater time of life of the surfaces covered with asphalt.

The application of the compositions of the invention like anti-stripping agents of asphalt, results in a smaller acid particle absorption by the surface of the aggregate, and allows reaching the asphalt mixtures high levels of resistance and elasticity. The compositions of the invention change the physical and chemical characteristics of the asphalt mixture particles with the aggregate, favoring the consolidation of the asphalt mixture to the surface of the aggregate, avoiding the stripping and prolonging with this the time of life of the asphalt pavement.

Due to these characteristics, these compositions can be used, for example for the obtaining of asphalt carpets with greater time of life, application in which the resistance to the water, a good superficial finish and a fast increase in the compressive strength at early ages, are important requirements.

With the anti-stripping compositions of the invention agreed results with specifications related to the index of retained strength and stripping of asphalt are obtained, in comparison with the typical results of other used agents. Also, the values that are obtained in such parameters are superior than the reported values for other agents, including the obtained for the Ca(OH)₂.

The anti-stripping compositions of the invention allow generating asphaltic concrete with greater compressive strength, without presenting the undesirable effects that are caused by anhydrous calcium sulphate in other materials, as well as an important diminution in the stripping effect of surfaces covered with asphalt.

Like a way to illustrate the present invention, the following examples are presented, without it limits the reach of the same one.

### EXAMPLE 1

### Obtaining of the Cement Portland-Anhydrite Anti-Stripping Agent

The anti-stripping agent was obtained by the process described by Garcia Luna⁹. Anhydrous gypsum from the process of obtaining hydrofluoric acid (HF) as remainder product, were fed directly on a fines separator; the resulting retained material was ground together with Portland cement clinker in an industrial mill during 1 hour in presence of a milling additive. Finally the resulting product was mixed with the anhydrous gypsum fines that were separated previously to the grounding.

For obtaining the wished anti-stripping composition, the proportions in weight of each one of their components were previously determined before their joint milling.

The anti-stripping composition obtained presented a fineness of mesh 325 in a 99% like minimum and a compressive strength according to norm ASTM, between ≧180 Kg/cm² to ≧250 Kg/cm² to the 7 and 28 day corresponding.

In table 1 are shown the physical and chemical characteristics of mixture 40:60 of Portland cement:anhydrite.

TABLE 1

| Components and | | |
|---|---|---|
| characteristics | Amount | Method |
| SiO₂ [%] | 9-10 | ASTM-C114 |
| Al₂O₃ [%] | 0-2 | ASTM-C114 |
| Fe₂O₃ [%] | 0-1.3 | ASTM-C114 |
| CaO [%] | 50-60 | ASTM-C114 |
| MgO [%] | 0-0.2 | ASTM-C114 |
| K₂O [%] | 0-0.3 | ASTM-C114 |
| Na₂O [%] | 0-0.2 | ASTM-C114 |
| SO₃ [%] | 34-38 | ASTM-C114 |
| Free lime [%] | 0-0.3 | ASTM-C114 |
| LOI [%] | 0-1.0 | ASTM-C114 |
| Mesh 325 [%] | ≧80 | ASTM-C430 |
| Blaine (g/cm²) | ≧5000 | ASTM-C204 |
| Initial setting time (min) | 20-25 | ASTM-C191 |
| Final setting time (min) | 48-55 | ASTM-C191 |
| 24 hrs resistance | ≧85 | ASTM-C109 |
| (Kg/cm²) | | |
| 3 days resistance | ≧135 | ASTM-C109 |
| (Kg/cm²) | | |
| 7 days resistance | ≧180 | ASTM-C109 |
| (Kg/cm²) | | |
| 28 days resistance | ≧250 | ASTM-C109 |
| (Kg/cm²) | | |
| Autoclave expansion [%] | ≧0.03 | ASTM-C151 |

### EXAMPLE 2

### Obtaining of the Asphaltic Concrete Composition of the Invention

Stony aggregates previously dampened in 2 to 3% on their condition of saturated dry surface, were obtained from a load hopper by a band. Later the obtained anti-stripping composition in example 1 was added in form of dust to the aggregate bed formed on the band, in a proportion from the 0.5 to the 3.0% in weight with respect to the total weight of the asphaltic concrete composition, until obtaining a homogenous mixture. The described mixture previously was mixed with hot conventional asphalt in a continuous way in a standard mixer until obtaining a homogenous mixture.

### EXAMPLE 3

### Comparison of the Stripping Effect in Asphalt

Diverse obtained mixtures of asphaltic concrete according to example 2, as well as mixtures of asphaltic concrete using Ca(OH)₂ like anti-stripping agent, were elaborated using stony aggregates and conventional asphalt. In this case, the anti-stripping agents were added to the mixture in a percentage of the 1.5% in weight with respect to the total weight, as much dry as dampened. Later the resulting value of compressive strength for each one of the samples was determined, obtaining the index of retained strength in the mixtures that contained the dampened anti-stripping agent.

As it can be observed in table 2, the value of the index of retained strength for the mixtures of asphaltic concrete containing Ca(OH)₂ and the anti-stripping composition of anhydrite described here (see table 1, 40:60), resulting in the obtaining of minimum similar values of 93% in the index of retained strength and 90% in the stripping values, for the mixtures under test.

TABLE 2

| | | | Compressive | Index of | |
|---|---|---|---|---|---|
| | | Bulk | strength | retained | Stripping |
| Additive | Condition | density | (kPa)* | strength (%) | (%) |
| Lime w/o | Dry | 2.330 | 5587 | | |
| Lime w/o | Wet | 2.332 | 5024 | | 90 |
| Lime w | Wet | 2.333 | 5217 | 93 | |
| 40:60 w | Wet | 2.335 | 5184 | 93 | 90 |

*Average value of three determinations.

### EXAMPLE 4

### Comparison of the Stripping Effect in the Asphaltic Concrete Using Diverse Aggregates

Mixtures of asphaltic concrete were obtained with different stony aggregates and they were evaluated as it is mentioned in example 3. In this case aggregates who represent a good section of the type of stony aggregates used commonly through New Mexico, USA, were used.

The values obtained for the index of retained strength are in table 3. As it can be observed, for the last three types of mixtures of asphaltic concrete, the value obtained for the anti-stripping composition of anhydrite described here (see table 1, 40:60) was at least a 7% superior to the obtained for Ca(OH)₂.

TABLE 3

| | Index of retained strength (%) | |
|---|---|---|
| Aggregate Type and Source | Hydrated Lime | Hydrated 40:60 |
| Hope Pit, Limestone | 93 | 93 |
| McKenzie Pit, Sand and Gravel | 92 | 93 |
| Santa Ana Pit, Limestone | 122 | 124 |
| Baker Pit, Sand and Gravel | 89 | 95 |

### REFERENCES

1. Crews, Everett. 2001. Fluid concentrates of modified mineral acid salts. U.S. Pat. No. 6,194,471.
2. Isobe, Kazuo. 2003. Asphalt-additive composition. EPB 0985703.
3. Guilbault, Lawrence James. 2003. Polymeric asphalt anti-stripping agent. EPA 1367096.
4. Schulz, Gerald Owen. 2002. Antistrip latex for aggregate treatment. U.S. Pat. No. 6,403,687.
5. Dunning, Robert L. 1993. Aggregate treatment. U.S. Pat. No. 5,262,240.
6. Burke, William J. 1993. Asphalt concrete composition and method of making same. U.S. Pat. No. 5,219,901.
7. Klein, Alexander. 1964. Calcium aluminosulfate and expansive cements containing same. U.S. Pat. No. 3,155,526.
8. Halstead, Moore. 1962. J. Applied of Chemistry, vol. 12, 413-415.
9. Garcia Luna, Armando. 2003. Composiciones cementantes que contienen anhidrita y procedimiento para su fabricacion. Solicitud de patente MX 011064.

1-32. (canceled)

33. An asphaltic concrete composition resistant to stripping that comprise an asphalt cementitious, a stony aggregate and an anti-stripping composition, wherein the anti-stripping composition is constituted by a mixture that comprise:
a) Portland cement in a percentage in weight with respect to the total weight of anti-stripping composition from 25 to 40%, and
b) Anhydrite in a percentage in weight with respect to the total weight of anti-stripping composition from 60 to 75%.

34. The asphaltic concrete of claim 33, wherein the Portland cement is selected of the group that comprise type-1, type-2, type-3, type-4 and type-5.

35. The asphaltic concrete of claim 34, wherein the Portland cement is provided in form of clinker.

36. The asphaltic concrete of claim 33, wherein the anti-stripping composition comprise:
a) Sulphates in a percentage in weight with respect to the total weight of the anti-stripping composition of 38%,
b) CaO in a percentage in weight with respect to the total weight of the anti-stripping composition of 60%, and
c) Alumina in a percentage in weight with respect to the total weight of the anti-stripping composition of 2%.

37. The asphaltic concrete of claim 36, wherein the anti-stripping composition comprise:

| | Percentage in weight with respect to the |
|---|---|
| | total weight of the anti-stripping |
| Component | composition (%) |
| SiO₂ | 9-10 |
| Al₂O₃ | 0-2 |
| Fe₂O₃ | 0-1.3 |
| CaO | 50-60 |
| MgO | 0-0.2 |
| K₂O | 0-0.3 |
| Na₂O | 0-0.2 |
| SO₃ | 34-38 |
| Free lime | 0-0.3 |
| PPI | 0-1.0 |

38. The asphaltic concrete of claim 33, wherein the anti-stripping composition has a mesh fineness of 325 in a 80% as minimum.

39. The asphaltic concrete of claim 38, wherein the anti-stripping composition has a mesh fineness of 325 in a 99%.

40. The asphaltic concrete of claim 33, wherein the anti-stripping composition has a minimum compressive strength of 180 Kg/cm² at 7 days and 250 Kg/cm² at 28 days.

41. The asphaltic concrete of claim 33, wherein the Portland cement is in a percentage in weight with respect to the total weight of anti-stripping composition of 40%, and the anhydrite in a percentage in weight with respect to the total weight of anti-stripping composition of 60%.

42. The asphaltic concrete of claim 33, wherein the Index of retained strength is of 93% as minimum.

43. The asphaltic concrete of claim 42, wherein the anti-stripping composition is in a percentage in weight with respect to the total weight of the asphaltic concrete from 0.5 to 3.0%.

44. The asphaltic concrete of claim 43, wherein the anti-stripping composition is in a percentage in weight with respect to the total weight of the asphaltic concrete from 1.0 to 2.0%.

45. A method to improve the anti-stripping properties of asphaltic concrete compositions, wherein the method comprise to add to the asphaltic concrete composition an anti-stripping composition constituted by a mixture that comprise:
a) Portland cement in a percentage in weight with respect to the total weight of anti-stripping composition from 25 to 40%,
b) Anhydrite in a percentage in weight with respect to the total weight of anti-stripping composition from 60 to 75%.

46. The method of claim 45, wherein the Portland cement is selected from a group that comprise type-1, type-2, type-3, type-4 and type-5.

47. The method of claim 46, wherein the Portland cement is provided in clinker form.

48. The method of claim 45, wherein the anti-stripping composition comprise:
a) Sulphates in a percentage in weight with respect to the total weight of the anti-stripping composition of 38%,
b) CaO in a percentage in weight with respect to the total weight of the anti-stripping composition of 60%, and
c) Alumina in a percentage in weight with respect to the total weight of the anti-stripping composition of 2%.

49. The method of claim 48, wherein the anti-stripping composition comprise:

| | Percentage in weight with respect to the |
|---|---|
| | total weight of the anti-stripping |
| Component | composition (%) |
| SiO₂ | 9-10 |
| Al₂O₃ | 0-2 |
| Fe₂O₃ | 0-1.3 |
| CaO | 50-60 |
| MgO | 0-0.2 |
| K₂O | 0-0.3 |
| Na₂O | 0-0.2 |
| SO₃ | 34-38 |
| Free lime | 0-0.3 |
| PPI | 0-1.0 |

50. The method of claim 45, wherein the anti-stripping composition has a mesh fineness of 325 in a 80% as minimum.

51. The method of claim 50, wherein the anti-stripping composition has a mesh fineness of 325 in a 99%.

52. The method of claim 45, wherein the anti-stripping composition has a minimum compressive strength of 180 Kg/cm² at 7 days and 250 Kg/cm² at 28 days.

53. The method of claim 45, wherein the Portland cement is in a percentage in weight with respect to the total weight of the anti-stripping composition of 40%, and the anhydrite in a percentage in weight with respect to the total weight of anti-stripping composition of 60%.

54. The method of claim 45, wherein the anti-stripping composition is added to the asphaltic concrete in a percentage in weight with respect to the total weight of the asphaltic concrete from 0.5 to 3.0%.

55. The method of claim 54, wherein the anti-stripping composition is added to the asphaltic concrete in a percentage in weight with respect to the total weight of the asphaltic concrete from 1.0 to 2.0%.

56. The method of claim 45, wherein the anti-stripping composition is added to the asphaltic concrete in powder form.

57. The method of claim 45, wherein the anti-stripping composition is added to the asphaltic concrete in slurry form.

58. The use of a cementitious composition that comprise:
a) Portland cement in a percentage in weight with respect to the total weight of the cementitious from 25 to 40%, and
b) Anhydrite in a percentage in weight with respect to the total weight of the cementitious from 60 to 75%,
as anti-stripping agent of asphaltic concrete.

59. The use of claim 58, wherein the Portland cement is selected of the group that comprise type-1, type-2, type-3, type-4 and type-5.

60. The use of claim 59, wherein the Portland cement is provided in clinker form.

61. The use of claim 58, wherein the cementitious composition comprise:
a) Sulphates in a percentage in weight with respect to the total weight of the cementitious composition of 38%,
b) CaO in a percentage in weight with respect to the total weight of the cementitious composition of 60%, and
c) Alumina in a percentage in weight with respect to the total weight of the cementitious composition of 2%.

62. The use of claim 61, wherein the cementitious composition comprise:

| | Percentage in weight with respect to the |
|---|---|
| | total weight of the anti-stripping |
| Component | composition (%) |
| SiO₂ | 9-10 |
| Al₂O₃ | 0-2 |
| Fe₂O₃ | 0-1.3 |
| CaO | 50-60 |
| MgO | 0-0.2 |
| K₂O | 0-0.3 |
| Na₂O | 0-0.2 |
| SO₃ | 34-38 |
| Free lime | 0-0.3 |
| PPI | 0-1.0 |

63. The use of claim 58, wherein the cementitious composition has a mesh fineness of 325 in a 80% like minimum.

64. The use of claim 63, wherein the cementitious composition has a mesh fineness of 325 in a 99%.

65. The use of claim 58, wherein the cementitious composition has a minimum compressive strength of 180 Kg/cm² at 7 days and 250 Kg/cm² at 28 days.

66. The use of claim 58, wherein the Portland cement is in a percentage in weight with respect to the total weight of the cementitious of 40%, and the anhydrite in a percentage in weight with respect to the total weight of the cementitious of 60%.
